(19) United States
(12) Patent Application Publication
(10) Pub. No.: US 2024/0384151 A1
(43) Pub. Date: Nov. 21, 2024

(54) CLEAR, HIGH-DENSITY HEAVY BRINE-BASED FLUIDS FOR DOWNHOLE APPLICATIONS

(71) Applicant: SAUDI ARABIAN OIL COMPANY, Dhahran (SA)

(72) Inventor: Elizabeth Q. CONTRERAS, Houston, TX (US)

(73) Assignee: SAUDI ARABIAN OIL COMPANY, Dhahran (SA)

(21) Appl. No.: 18/319,272

(22) Filed: May 17, 2023

(51) Int. Cl. C09K 8/05; C09K 8/66; E21B 43/27

(52) U.S. Cl. CPC C09K 8/05; C09K 8/665; E21B 43/27

(57) ABSTRACT

Compositions, methods and systems including a clear heavy brine-based fluid having a solute of calcium nitrate tetrahydrate, sodium metatungstate, and any combination thereof; and an aqueous carrier fluid, wherein the clear heavy brine-based fluid has a density equal to or greater than about 1.5 g/mL, including in the range of about 1.5 g/mL to about 3 g/mL.

### FIELD OF THE DISCLOSURE

The present disclosure relates generally to oilfield production and, more particularly, to clear, high-density, solids-free heavy (high-density) brine-based compositions, methods, and systems related thereto.

### BACKGROUND OF THE DISCLOSURE

Heavy (i.e., high-density) brine-based fluids for subterranean oil and gas applications, such as drilling applications and completion applications, require high densities to suspend additives and solid particulates, control pressures, prevent formation caving, and facilitate pulling of dry pipe, among other things. The importance of primary well control, during the drilling and construction of a well, requires completion fluids to minimize formation damage and to control reservoir formation pressures, increasing production.

Current heavy brine-based fluids are clear and employ monovalent and divalent salts (weighting agents) to achieve required high-density heavy brine-based fluids (currently having a density of about 1.7 grams/milliliter (g/mL) to about 2.4 g/mL). Salts include alkali metals like sodium, potassium, cesium; alkali earth metals like calcium, magnesium, and beryllium; halogens like chlorine, bromine; and zinc. Current heavy brine-based fluids typically contain zinc or are composed of three salts.

High salt-content heavy brine-based fluids can result in the release of soluble trace metals, like zinc, into the environment, which has significant antagonistic effects and are acutely toxic. Moreover, salts such as zinc bromide play a role as a pollutant in the refining process, and cesium formate have low supply and are costly. In addition, safely disposing of waste fluids with minimal health, environment, and safety impact, further drives cost up. Corrosion to downhole hardware, casing, and tubing is additively costly.

Heavy brine-based fluids further require a number of additives that must remain in suspension during oil and gas applications. Such additives include polymer additives (e.g., viscosifying agents, rheology modifiers, fluid loss additives, bridging polymers, and the like). Stabilization and suspension of these polymers in aqueous fluids with high salinity and high total dissolved solids (TDS) are challenging for oil and gas applications (e.g., drill-in applications, completion applications, and the like).

High-stakes wells, particularly in deep-water sectors, require drilling and completion fluids with multifunctional capabilities, performing multiple tasks efficiently. The criteria and benefits of such fluids include being solids free, high-density, clear (which may include slight coloring, such as a yellow clear (transparent) solution), rheological stability at high pressures and wide temperature ranges, environmentally friendly, and having neutral to high pH to avoid damage to a wellbore, such damage which would otherwise negatively impact productivity.

For example, completions fluid design, particularly for use in complex wells, should be based on a detailed study of reservoir characteristics at downhole conditions (e.g., high pressures and wide temperature ranges) to maintain sufficient hydrostatic pressure in the well. Completion fluids are placed against producing formations while conducting operations such as open-hole completions, well-cleanouts, well killing, hardware replacement, gravel packing, and the like. Completion fluids require solids-free or extremely clean fluids to protect productive zones at the formation face. Solids-free, clean fluids will diminish formation damage and skin.

Accordingly, there is a need for environmentally friendly, solids-free, heavy brine-based fluids that are amendable to polymer additives.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure includes a clear heavy brine-based fluid. The clear heavy brine-based fluid includes a solute of calcium nitrate tetrahydrate or sodium metatungstate and an aqueous carrier fluid, wherein the clear heavy brine-based has a density equal to or greater about than about 1.5 g/mL.

In another embodiment consistent with the present disclosure includes a method of introducing a clear heavy brine-based fluid into a subterranean formation. The clear heavy brine-based fluid includes a solute of calcium nitrate tetrahydrate or sodium metatungstate and an aqueous carrier fluid, wherein the clear heavy brine-based has a density equal to or greater than about 1.5 g/mL.

In another embodiment consistent with the present disclosure, includes a system including a drill string extendable into a wellbore from a drilling platform and conveying a clear heavy brine-based to a drill bit arranged at a distal end of the drill string.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 shows an illustrative schematic of a system that can deliver the clear heavy brine-based fluids of the present disclosure to a subterranean (downhole) location.

FIG. 2 shows an illustrative schematic of a system that can drill a wellbore using the clear heavy brine-based fluids of the present disclosure into a subterranean formation.

FIG. 3 is a photograph of a sample of the Ca(NO₃)₂·4 H₂O Base Fluid stored for 1 year at RT.

FIG. 4 shows a chart of densities of samples of Ca(NO₃)₂·4 H₂O Base Fluid at varying concentrations.

FIG. 5 is a photograph of a sample of the (Na)₆W₁₂O₃₉·H₂O Base Fluid stored for nine (9) months at 4° C.

FIG. 6 shows a chart of densities of samples of (Na)₆W₁₂O₃₉·H₂O Base Fluid at varying concentrations.

FIG. 7 is a photograph of various samples of 0.5% Aqueous (Na)₆W₁₂O₃₉·H₂O Base Fluid solutions.

FIG. 8 is temperature-dependent solubility chart of (Na)₆W₁₂O₃₉·H₂O Base Fluid at varying concentrations.

### DETAILED DESCRIPTION

Embodiments of the present disclosure will now be described in detail with reference to the accompanying Figures. Like elements, in the various figures, may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

The present disclosure relates generally to oilfield production and, more particularly, to clear, solids-free heavy (i.e., high-density) brine-based fluids, methods, and systems related thereto.

The present disclosure provides environmentally friendly, high-density, solids-free heavy brine-based fluids, referred to herein as clear heavy brine-based fluids. The clear heavy brine-based fluids demonstrate high-density (above about 10 pounds per gallon (ppg), such as in the range of about 10 ppg to about 24 ppg, or about 12 ppg to about 20 ppg, or about 19 ppg, encompassing any value and subset therebetween) suitable for use in oil and gas applications, particularly primary well control for various drilling and completion applications to maintain sufficient hydrostatic pressure in a wellbore. The clear heavy brine-based fluids are further solids-free, zinc-free, cesium-free, bromine-free, and chlorine-free; such solids are capable of inducing formation damage to producing formations. The clear heavy brine-based fluids are solids-free at a wide range of temperatures, such as in the range of about −20° C. to about 150° C., including room temperature (RT) and at pressures that equate to primary well control applications, and further exhibit good rheological measurements, fluid loss control, and corrosion rates at such temperatures and pressures. Moreover, the clear heavy brine-based fluids are environmentally friendly, and thus exhibit low toxicity.

The solids-free nature of the clear heavy brine-based fluids of the present disclosure may be used in various oil and gas applications. Such applications include, but are not limited to, drill-in fluid applications, completion applications, workover applications, packer applications, and the like. In particular, the clear heavy brine-based fluids described herein are used for primary well control for various drilling and completion applications to maintain sufficient hydrostatic pressure in a wellbore. Advantageously, the clear heavy brine-based fluids of the present disclosure have the density and rheology needed, as well as being solids-free, to perform these operations, and to actively suspend additives and solid particulates (collectively “additives”) when necessary.

It is to be noted that while the present disclosure may describe the clear heavy brine-based fluids of the present disclosure with reference to the aforementioned applications, any other oil and gas applications requiring a dense fluid may utilize the clear heavy brine-based fluids described herein, without departing from the scope of the present disclosure.

The clear heavy brine-based fluids described herein overcome a number of challenges that have been associated with the preparation of clear, high-density, solids-free heavy brine-based fluids. Temperature stability is key to keeping heavy brine-based fluids solids-free and clear. In particular, to achieve high density in an aqueous (non-hydrocarbon and clear) fluid, one or more solute(s) must be dissolved in an aqueous solution, and such dissolution is highly susceptible to temperature changes. For example, RT (˜21° C.) and low temperature (˜4° C.), precipitation of solutes occurs due to impacts of temperature changes on solubility. Further, the rate of solubility for solutes going into solution, can increase with decreasing temperatures (e.g., for gas molecules, as temperature increases, solubility decreases for gas fluids, such as CO₂, thereby increasing pH).

Clear heavy brine-based fluids according to the present disclosure are prepared using either a calcium nitrate tetrahydrate (Ca(NO₃)₂·4 H₂O) solution or a sodium metatungstate ((Na)₆W₁₂O₃₉·H₂O) solution, each functioning to impart density, lubricity, and biocidal qualities. The clear heavy brine-based fluids of the present disclosure are used at least for primary well control and are characterized as having a high-density (i.e., heavy), transparency, neutral to high pH, and thermal stability.

The clear high-density (about 1.5 to about 3.0 g/mL) water-based, brine-based fluids are prepared in an aqueous carrier fluid, which may include freshwater, deionized water, brine, produced water, seawater, and any combination thereof. The carrier fluid can be the continuous phase or in the dispersed phase of an oil-in-water (o/w) or water-in-oil solution (w/o), as well, without departing from the scope of the present disclosure. The w/o formulations provide result in high densities for oil-based muds, e.g., 20% water to 80% oil; 10% to 90%; 5% to 95%; 1% to 99%; 0.5% to 99.5%; 0.2% to 99.8%, encompassing any value and subset therebetween, based on desired density. In turn, the materials prepared with hydrophobic properties, such as an organic molecule (e.g., 2,2′-bipyridyl (bpy), 1-pyridin-2-yl (py), pyrazol-1-yl (pz), and 1-methylimidazol-2-yl (mim) rings) to solubilize brine in organic solvent-based solutions, including solutions with an oil continuous phase (w/o) or dispersed phased (o/w) formulation, may be utilized as well, without departing from the scope of the present disclosure.

In one or more instances, for example, the present disclosure provides a clear heavy brine-based fluids of an inorganic-organic hybrid solution based on metatungstate and tetraethylenepentamine (˜50% linear, 41% branched, 5% triethylenetetramine, 4% polyethylene polyamines; N-(2-aminoethyl)-N′-{2-{(2-aminoethyl)amino}ethyl}-1,2-ethanediamine); TEPA), thus yielding a heavy brine-based, clear fluid with valuable hydrophilic properties using an aliphatic linear chain with amine groups, incorporated herein by reference in its entirety (demonstrating the synthesis of hydrophobic molecules using 2,2′-bpy and 4,4′-bpy)).

Other solutions may include, but are not limited to, NaWO₄·2H₂O; (NH₄)6H₂W₁₂O₄₀·xH₂O; and applies to phosphometals, metametals, parametals, such as tin(II) phosphometal, silver tungstate (Ag₂WO₄), cesium tungstate (Cs₂WO₄) heteropoly salts and polytungstate salts, including multinary metal salts and compositions, and combination of the same.

The concentration of Ca(NO₃)₂·4 H₂O may be included in an aqueous carrier fluid in the range of about 0.2 wt. % to about 440 wt. % of the aqueous carrier fluid, encompassing any value and subset therebetween, such as 0.2 wt. % to about 320 wt. %. In particular embodiments, the concentration of Ca(NO₃)₂·4 H₂O may be included in an aqueous carrier fluid in the range of about 0.2 wt. % to about 200 wt. %, encompassing any value and subset therebetween, such as 136 wt. % to 200 wt. %. At these concentrations, the density of the Ca(NO₃)₂·4 H₂O clear heavy brine-based fluids is on average equal to or greater than about 1.5 g/mL to about 3.0 g/mL, encompassing any value and subset therebetween; however, in some instances the density of the Ca(NO₃)₂·4 H₂O clear heavy brine-based fluids are prepared at gradient concentrations and may be as low as about 1.2 g/mL (see FIG. 4). The stability of the clear heavy brine-based fluids described herein refers to the length of time the fluids are clear and do not precipitate or form crystals. The stability of the Ca(NO₃)₂·4 H₂O clear heavy brine-based fluids is at least one (1) year at RT.

The concentration of (Na)₆W₁₂O₃₉·H₂O (solute) may be included in an aqueous carrier fluid in the range of about 0.2 wt. % to about 150 wt. % (where 4 g of solute goes into 1 g of water) of the aqueous carrier fluid, encompassing any value and subset therebetween, such as 35 wt. % to 120 wt. %, or 50 wt. % to 90 wt. %, or 90 wt. % to 120 wt. %. At these concentrations, the density of the (Na)₆W₁₂O₃₉·H₂O clear heavy brine-based fluids is on average equal to or greater than about 1.5 g/mL, such as in the range of about 1.5 g/mL to about 3 g/mL, encompassing any value and subset therebetween; however, in some instances the density of the (Na)₆W₁₂O₃₉·H₂O clear heavy brine-based fluids are prepared at gradient concentrations and may be as low as about 1.4 g/mL (see FIG. 6). The stability of the clear heavy brine-based fluids described herein refers to the length of time the fluids are clear and do not precipitate or form crystals. The stability of the (Na)₆W₁₂O₃₉·H₂O clear heavy brine-based fluids is at least nine months at 4° C.

In one or more instances, the clear heavy brine-based fluids, whether comprising Ca(NO₃)₂·4 H₂O or (Na)₆W₁₂O₃₉·H₂O, may comprise one or more additives, depending on the particular oil and gas application, for example. Such additives may include, but are not limited to, a buffering agent, a corrosion inhibitor, counter ions (e.g., on molecules, such as polymers), secondary weighting agents, chelates, viscosifiers, surfactants, ligand modifiers, stabilizers, and the like, and any combination thereof. Other oil and gas application additives may also be included in the clear heavy brine-based fluids described herein, without departing from the scope of the present disclosure.

Suitable buffering agents include, but are not limited to tris(hydroxymethyl)aminomethane solution (pKa of 8.07, TRIS buffer); 3,4-dihydroxyphenethylamine (pKa of 8.93); 2-(4-Aminophenyl)-5-aminobenzimidazole (pka of 11.2); NaOH (pka 15.7); and any combination thereof. Other suitable buffering agents include, but are not limited to, Bronsted acids and Bronsted bases, such as citric acid and sodium hydroxide, or Bronsted acids and Lewis bases, such as citric acid and monoethanolamine, and buffering agents produced from Lewis acids and Lewis bases, such as boric acid and monoethanolamine. Other examples of suitable Bronsted acids include, but are not limited to, mineral acids, such as hydrochloric acid, sulfuric acid, phosphoric acid, and nitric acid, and organic acids such as tartaric acid and benzene sulfonic acid, and methane sulfonic acid. Other examples of Bronsted bases include, but are not limited to, sodium carbonate, sodium bicarbonate, potassium hydroxide, and ammonium hydroxide. Other examples of Lewis bases include, but are not limited to, diethanolamine, triethanolamine, triisopropanolamine, and dimethylaminoethanol. Any combination of the foregoing may additionally be included in the clear heavy brine-based fluids, without departing from the scope of the present disclosure. The buffering agent may be included in the clear heavy brine-based fluids of the present disclosure in an amount sufficient to achieve a pH of 7.0 (neutral) or greater (more basic), encompassing any value and subset therebetween, thereby preventing or minimizing corrosion (e.g., of casing) and formation damage. Generally, the buffering agent(s) may be included in the clear heavy brine-based fluids of the present disclosure to achieve a pH in the range of 7.0 to about 10.0, or about 7.0 to about 8.0, encompassing any value and subset therebetween.

Suitable corrosion inhibitors include, but are not limited to, an acetylenic alcohol, a Mannich condensation product, an unsaturated carbonyl compound, an unsaturated ether compound, a formamide, a formate, a carbonyl compound, a terpene, an aromatic hydrocarbon, cinnamaldehyde, a cinnamaldehyde derivative, a fluorinated surfactant, a quaternary derivative of heterocyclic nitrogen base, a quaternary derivative of a halomethylated aromatic compound, and any combination thereof. In one or more aspects, the corrosion inhibitor(s) may be present in an amount of at least 0.1 wt. % of the aqueous carrier fluid, such as in the range of about 0.1 wt. % to about 15 wt. % of the aqueous carrier fluid, encompassing any value and subset therebetween.

Optionally, the clear heavy brine-based fluids of the present disclosure may include one or more secondary weighting agents and bridging materials to further increase the density of the clear heavy brine-based fluids, as well as increase buoyancy of solids (e.g., proppant particulates, wellbore cleaning, cuttings, formation particles, contaminants and fluids). Suitable weighting agents include, but are not limited to, sand, barite (barium sulfate), calcium carbonate, hematite, fly ash, silica sand, ilmenite, manganese oxide, manganese tetraoxide, zinc oxide, zirconium oxide, iron oxide, fly ash, and any combination thereof. Additional weighting agents, alone or in combination with the aforementioned weighting agents, include, but are not limited to, calcium iodide, magnesium iodide, strontium iodide, calcium bromide and calcium iodide, calcium bromide, calcium chloride, magnesium bromide, magnesium chloride, strontium bromide, strontium chloride for divalent chemical formulations, sodium bromide, sodium chloride, sodium iodide, potassium bromide, potassium chloride, potassium iodide, lithium bromide, lithium chloride, lithium iodide, cesium bromide, cesium chloride, cesium iodide, rubidium bromide, rubidium chloride, rubidium iodide for monovalent formulations, and any combination thereof. In one or more aspects, the weighting agent(s) may be included in the clear heavy brine-based fluids described herein in an amount of about 100 pounds per barrel (ppb) to about 400 ppb of the aqueous carrier fluid, encompassing any value and subset therebetween.

One or more chelates (also referred to as chelating agents) may be included in the clear heavy brine-based fluids of the present disclosure to stabilize or prevent precipitation of damaging compounds and/or to treat or remove scale within a wellbore. Suitable chelates include, but are not limited to, ammonium, hydroxyethylenediaminetetraacetic acid (EDTA), N-(2-hydroxethyl)ethylenediaminetriacetic acid (HEDTA), hydroxyethyliminodiacetic acid (HEIDA), methylglycine diacetic acid (MGDA), L glutamic acid, N,N-diacetic acid (GLDA), ethylenediaminedisuccinic acid (EDDS), beta-alaninediacetic acid (beta-ADA), diethylenetriaminepentaacetic acid (DTPA), cyclohexylenediaminetetraacetic acid (CDTA), nitrilotriacetic acid (NTA), diphenylaminesulfonic acid (DPAS), phosphonic acid, alkylphosphonic acids or phosphonate salts where the alkyl group is any that provides sufficient aqueous solubility in the pH range of interest, citric acid, iminodiacetic acid, gluconic acid, and ammonium, alkali (Group I metal) or alkaline-earth (Group 2 metal) salts thereof, and any combination thereof. In one or more aspects, the chelating agent may be included in the clear heavy brine-based fluids of the present disclosure in an amount in the range of about 1 wt. % to about 20 wt. % of the aqueous carrier fluid, encompassing any value and subset therebetween.

In one or more aspects, the clear heavy brine-based fluids of the present disclosure may include one or more stabilizers and, optionally, a co-stabilizer. Such stabilizers can be used to impart thermal stability to the clear heavy brine-based fluids, for example. Suitable stabilizers include, but are not limited to, sorbitol, glycerol, xylitol, mannitol, diglycerol, polyethylene glycol, ethylene glycol, propylene glycol, polyols, and any combination thereof. Suitable co-stabilizers include, but are not limited to, amines, amino alcohols, hydroxylamines, hydrazines, erythorbic acid and derivative erythorbate salts, ascorbic acid and derivative ascorbate salts, citric acid and derivative citrate salts, and any combination thereof. Examples of amines include, monoethanolamine (MEA), diethanolamine (DEA), triethanolamine (TEA), ethylenediamine (EDA), diethylenetriamine (DETA), triethylenetetramine (TETA), tetraethylenepentamine (TEPA), pentaethylenetetramine (PETA), pentaethylenehexamine (PEHA), aminoethylpiperazine (AEP), ethyleneamine E-100, piperazine, diethylhydroxylamine (DEHA), diethylaminoethanol (DEAE), dimethylethanolamine (DMEA), methoxypropylamine (MOPA), morpholine, n-aminopropylmorpholine (APM), 4-[2-hydroxyethyl]morpholine, diglycolamine, N-[3-aminopropyl]diethanolamine, aminoethylethanolamine (AEEA), diethylhydroxylamine (DEHA), dimethylhydroxylamine (DMHA), hydroxylamine, and any combination thereof.

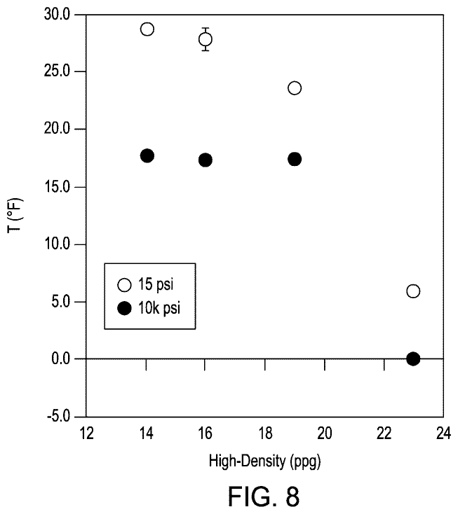

Increasing the density and clarity of a brine, and decreasing the true crystallization temperature (TCT (or saturation or freeze point)) or pressurized crystallization temperature (PCT), may be achieved by using one or more stabilizers, such as glycols (e.g., ethylene glycol, propylene glycol) and/or glycerols. The TCT (and effecting clarity) of a brine is the temperature at which a solid phase begins to form, resulting in a mixture of solid particles and solution. These solids may be salt crystals or water crystals (ice). The TCT is based on the salts dissolved in the brine and is dependent on the weight percent of salt (density), where TCT typically increases with increasing brine density after the eutectic point. However, as described hereinbelow (see FIG. 8), the TCT of the clear heavy brine-based fluids of the present disclosure does not increase with increasing density, but rather decreases at both ambient and 10,000 pounds per square inch (psi) confined pressure. This is advantageous because once salt crystals form, they are difficult to remove and can block any system using a brine; indeed, rheological measurements change as increased resistance to fluid flow occurs as solids form and sagging in a brine significantly reduces density due to settling of soluble salts, which can lead to an underbalance situation. The rheology of the clear heavy brine-based fluids may further be adjusted using one or more optional viscosifiers. Suitable viscosifiers include, but are not limited to polymers consisting of brines, biopolymers, celluloses, cellulose derivatives (e.g., carboxymethyl cellulose), gums, guar, guar derivatives, scleroglucan polysaccharides, xanthan polysaccharides, starches, starch ether derivatives, and any combination thereof. In one or more aspects, the viscosifier(s) may be present in the clear heavy brine-based fluids of the present disclosure in an amount in the range of about 0.2 wt. % to about 1 wt. % of the aqueous carrier fluid, encompassing any value and subset therebetween.

In yet other aspects, an optional surfactant may be included in the clear heavy brine-based fluids of the present disclosure. Suitable surfactants include, but are not limited to, arginine methyl esters, alkanolamines, alkylenediamides, alkyl ester sulfonates, alkyl ether sulfonates, alkyl ether sulfates, alkali metal alkyl sulfates, alkyl or alkylaryl sulfonates, sulfosuccinates, alkyl or alkylaryl disulfonates, alkyl disulfates, alcohol polypropoxylated and/or polyethoxylated sulfates, taurates, amine oxides, alkylamine oxides, ethoxylated amides, alkoxylated fatty acids, alkoxylated alcohols, ethoxylated fatty amines, ethoxylated alkyl amines, betaines, modified betaines, alkylamidobetaines, quaternary ammonium compounds, any derivative thereof, and any combination thereof. The surfactant(s) may be included in the clear heavy brine-based fluids of the present disclosure in an amount in the range of about 0.01 wt. % to about 20 wt. % of the aqueous carrier fluid, encompassing any value and subset therebetween.

One or more ligand modifiers may be included in the clear heavy brine-based fluids of the present disclosure and may include, but are not limited to, esters, anhydrides, amines, amides, quaternary ammonium salts, silicates, silyl ethers, siloxanes, esters, carbonates, ureas, carbamates, sulfoxides, sulfones, phosphoramides, silanes, acetals, and any combination thereof. In any aspect, the ligand modifiers may be included in the clear heavy brine-based fluids of the present disclosure in an amount in the range of about 0.01 wt. % to about 5 wt. % of the aqueous carrier fluid, encompassing any value and subset therebetween.

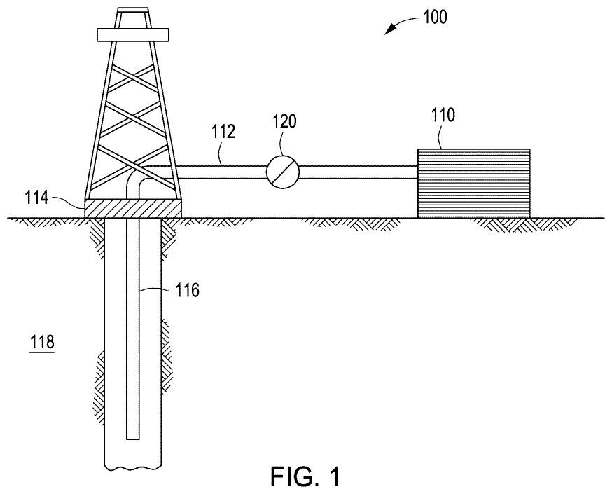

FIG. 1 shows an illustrative schematic of a system that can deliver the clear heavy brine-based fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 100 may include mixing tank 110, in which the clear heavy brine-based fluids of the embodiments herein may be formulated. The clear heavy brine-based fluids may be conveyed via line 112 to wellhead 114, where the clear heavy brine-based fluids enter tubular 116, tubular 116 extending from wellhead 114 into subterranean formation 118. Upon being ejected from tubular 116, the clear heavy brine-based fluids may subsequently penetrate into subterranean formation 118. Pump 120 may be configured to raise the pressure of the clear heavy brine-based fluids to a desired degree before introduction into tubular 116. It is to be recognized that system 100 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the clear heavy brine-based or a portion thereof may, in some embodiments, flow back to wellhead 114 and exit subterranean formation 118. In some embodiments, the clear heavy brine-based that has flowed back to wellhead 114 may subsequently be recovered and recirculated to subterranean formation 118, or otherwise treated for use in a subsequent subterranean operation or for use in another operation or industry.

It is also to be recognized that the disclosed clear heavy brine-based fluids for primary well control may also directly or indirectly affect the various downhole equipment and tools that may come into contact with the clear heavy brine-based fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

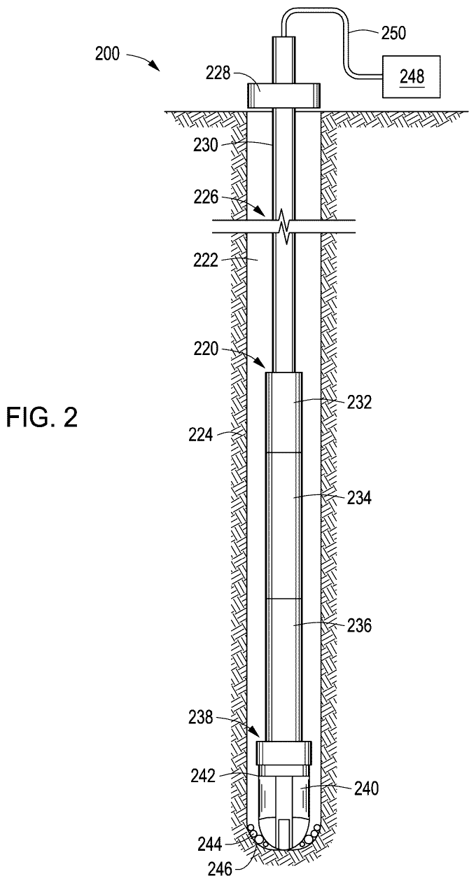

FIG. 2 shows an illustrative schematic of a system that can drill a wellbore using the clear heavy brine-based fluids of the present disclosure into a subterranean formation, according to one or more embodiments. FIG. 2 shows a drilling system 200 excavating a wellbore 222 through a formation 224. The drilling system 200 illustrated includes an elongated drill string 226 that receives a rotational force from a drive system 228 shown schematically represented on the surface and above an opening of the wellbore 222. Example embodiments of the drive system 228 include a top drive as well as a rotary table. A number of segments of drill pipe 230 are threadingly attached together to form an upper portion of the drill string 226. An optional swivel master 232 is schematically illustrated on a lower end of the drill pipe 230. Implementation of the swivel master 232 allows the portion of the drill string 226 above the swivel master 232 to be rotated without any rotation or torque being applied to the drill string 226 below the swivel master 232. A directional drilling assembly 234 is shown optionally provided on a lower end of the swivel master 232. The directional drilling assembly 234 may include gyros or other directional type devices for steering the lower end of the drill string 226. Also optionally provided is an intensifier 236 coupled on a lower end of the directional drilling assembly 234.

In one example, the pressure intensifier 236 receives the clear heavy brine-based fluids described herein at an inlet adjacent the drilling assembly 234, increases the pressure of the fluid, and discharges the fluid from an end adjacent a drill bit assembly 238 shown mounted on a lower end of the intensifier 236. The bit assembly 238 includes a drill bit 240, shown as a drag or fixed bit, but may also include extended gauge rotary cone type bits. Cutting blades 242 extend axially along an outer surface of the drill bit 240 and are shown having cutters 244. The cutters 244 may be cylindrically shaped members, and may also optionally be formed from a polycrystalline diamond material. Further provided on the drill bit 40 of FIG. 1 are nozzles 46 that are dispersed between the cutters 244 for discharging drilling fluid from the drill bit 240 during drilling operations. As is known, the fluid exiting the nozzles 246 provides both cooling of cutters 244 due to the heat generated by rock cutting action and hydraulically flushes cuttings away as soon as they are created. The drilling fluid also recirculates up the wellbore 222 and carries with it rock formation cuttings that are formed while excavating the wellbore 222. The clear heavy brine-based may be provided from a storage tank 248 shown on the surface that leads the fluid into the drill string 226 via a line 250.

Methods of treating a subterranean formation utilizing the clear heavy brine-based fluids for primary wellbore control of the present disclosure are provided herein. Methods include introducing the clear heavy brine-based fluids into a subterranean formation, such as using the system of FIG. 1. The clear heavy brine-based fluids may be introduced during a drilling operation. A drill string is provided (i.e., a string of drill pipe) having an attached drill bit. The clear heavy brine-based is pressurized and injected through the drill string and out of the drill bit as a wellbore is drilled. In one or more embodiments, the clear heavy brine-based fluids described herein may be used for completion operations, such as casing operations, gravel packing operations, stimulation operations (i.e., hydraulic fracturing), and the like, and any combination thereof, without departing from the scope of the present disclosure.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

### Example Embodiments

Embodiments disclosed herein include:

Embodiment A: A clear heavy brine-based fluid comprising: a solute of calcium nitrate tetrahydrate or sodium metatungstate; and an aqueous carrier fluid, wherein the clear heavy brine-based has a density equal to or greater about than about 1.5 g/mL.

Embodiment B: A method comprising: introducing a clear heavy brine-based into a subterranean formation, the clear heavy brine-based fluid comprising: a solute of calcium nitrate tetrahydrate or sodium metatungstate; and an aqueous carrier fluid, wherein the clear heavy brine-based has a density equal to or greater than about 1.5 g/mL.

Embodiment C: A system comprising: a drill string extendable into a wellbore from a drilling platform and conveying a clear heavy brine-based fluid to a drill bit arranged at a distal end of the drill string, the clear heavy brine-based fluid comprising: a solute of calcium nitrate tetrahydrate or sodium metatungstate; and an aqueous carrier fluid, wherein the clear heavy brine-based fluid has a density equal to or greater than about 1.5 g/mL.

Each of Embodiments A through C may have one or more of the following additional elements in any combination, as provided below:
Element 1: wherein the density is in the range of about 1.5 g/mL to about 3 g/mL.
Element 2: wherein the aqueous carrier fluid is selected from the group consisting of freshwater, deionized water, brine, seawater, produced water, and any combination thereof.
Element 3: further comprising an additive selected from the group consisting of a buffering agent, a corrosion inhibitor, a counter ion, a secondary weighting agent, a chelate, a viscosifier, a surfactant, a ligand modifier, a stabilizer, and any combination thereof.
Element 4: wherein the solute is calcium nitrate tetrahydrate.
Element 5: wherein the solute is calcium nitrate tetrahydrate and wherein the calcium nitrate tetrahydrate is present in the clear heavy brine-based fluid in an amount of from about 0.2 wt. % to about 200 wt. % of the aqueous carrier fluid.
Element 6: wherein the solute is sodium metatungstate.
Element 7: wherein the solute is sodium metatungstate and wherein the sodium metatungstate is present in the clear heavy brine-based fluid in an amount of from about 0.2 wt. % to about 150 wt. % of the aqueous carrier fluid.
Element 8: further comprising drilling a wellbore in the subterranean formation while introducing the clear heavy brine-based fluid as a primary well control fluid.
Element 9: further comprising fracturing the subterranean formation while introducing the clear heavy brine-based fluid.

By way of non-limiting example, exemplary combinations applicable to Embodiments A and C include: any one, more, or all of Elements 1-5 without limitation; or any one, more, or all of Elements 1-3, 6, and 7 without limitation.

By way of non-limiting example, exemplary combinations applicable to Embodiment B include: any one, more, or all of Elements 1-5, 8, and 9 without limitation; or any one, more, or all of Elements 1-3, 6-9 without limitation.

To facilitate a better understanding of the embodiments described herein, the following examples of various representative embodiments are given. In no way should the following examples be read to limit, or to define, the scope of the present disclosure.

### EXAMPLES

### Calcium Nitrate Tetrahydrate Examples

In the Examples below, various measurements were performed based on a calcium nitrate tetrahydrate (Ca(NO₃)₂·4 H₂O) Base Fluid, prepared as follows:

Dissolve up to 7 grams of Ca(NO₃)₂·4 H₂O into 1 mL deionized (DI) water for a 1.6 grams per cubic centimeter (g/mL) solution. Heat solution to a rolling boil for five minutes, then turn heat off and allow to cool slowly to RT.

The Ca(NO₃)₂·4 H₂O Base Fluid was thereafter stored at RT for more than 24 months.

### Example 1: Stability of Calcium Nitrate Tetrahydrate Base Solution

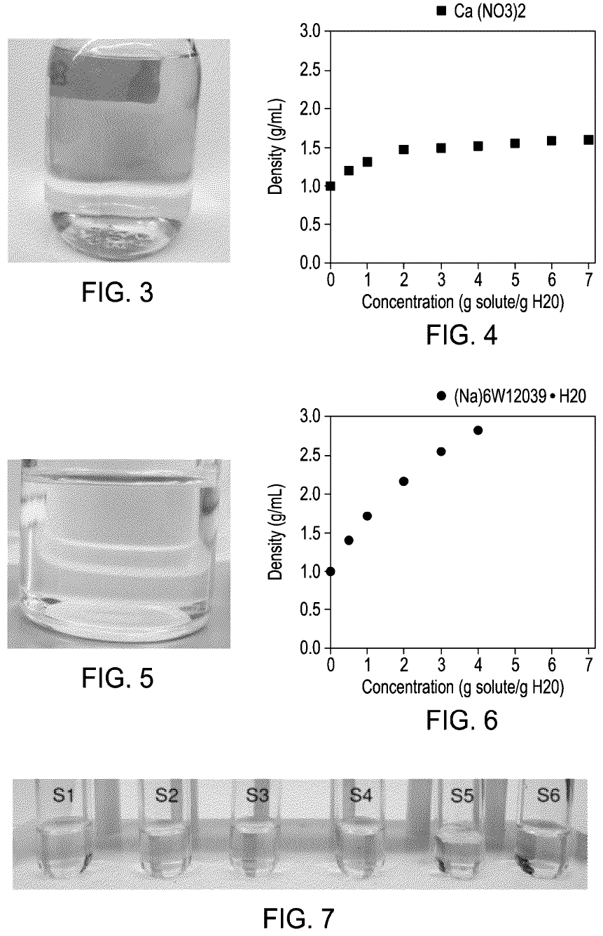

In this Example, the Ca(NO₃)₂·4 H₂O Base Fluid was tested for stability. A sample of the Ca(NO₃)₂·4 H₂O Base Fluid was stored for 2 years at RT, and thereafter, no precipitation or turbidity was observed. The results are shown in FIG. 3.

### Example 2: Density of Calcium Nitrate Tetrahydrate Base Solution

In this Example, after storage for 1 year at room temperature, the density of the Ca(NO₃)₂·4 H₂O Base Fluid was evaluated at varying concentrations. The results are shown in FIG. 4 and reported in Table 1.

TABLE 1

| Ca(NO₃)₂ • 4 H₂O | Property of solution |
|---|---|
| g solute/g H₂O | Density (g/mL) |
| 0.0 | 0.9904 |
| 0.5 | 1.2025 |
| 1.0 | 1.3124 |
| 2.0 | 1.4738 |
| 3.0 | 1.4897 |
| 4.0 | 1.516 |
| 5.0 | 1.5534 |
| 6.0 | 1.5863 |
| 7.0 | 1.6001 |

As shown, at concentrations equal to and greater than about 2.0 grams (g) of Ca(NO₃)₂·4 H₂O , the density is about 1.5 g/mL and above at RT (˜21° C.), which is suitable for oil and gas applications, primary well control, such as drill-in and completion operations.

### Example 3: Temperature Cycling of Buffered Calcium Nitrate Tetrahydrate Base Solution

Proper pH of neutral or high is required to minimize corrosion and formation damage for oil and gas applications. In this Example, chemical additives were used to determine the effects of pH and stability (Tables 2 and 3 below) of solutions after cycling them through low to high temperatures over the span of 4 days.

To the Ca(NO₃)₂·4 H₂O Base Fluid (1.6 g/mL), a buffering agent of 2-(4-Aminophenyl)-5-aminobenzimidazole (pka of 11.2) was added to prepare four samples as shown in Table 2:

TABLE 2

| | | |
|---|---|---|
| | Ca(NO₃)₂ • 4 H₂O | |
| Sample | Base Fluid | Buffer |

| | | | |
|---|---|---|---|
| C1 | 0 | mg | 5 mL |
| C2 | 3.6 | mg | 5 mL |
| C3 | 9.3 | mg | 5 mL |
| C4 | 18.5 | mg | 5 mL |

Each of samples C1-C4 were prepared by mixing the samples until completely dissolved and placing them in a water bath at 180° F. for 1 hour. Thereafter, the samples were removed from the water bath and allowed to cool to RT. The pH was measured with 4 temperature cycles: (1) Cycle 1 @ RT; (2) Cycle 2 @ 180° F.; (3) Cycle 3 @ RT; and (4) Cycle 4 @ 180° F. The samples were heated to 180° F. for 1 hour and then allowed to cool to RT. The results are shown in Table 3:

TABLE 3

pH

| Cycle | C1 | C2 | C3 | C4 |
|---|---|---|---|---|
| 1 | 5.38 | 7.14 | 7.47 | 7.78 |
| 2 | 5.28 | 7.17 | 7.20 | 7.82 |
| 3 | 5.09 | 7.16 | 7.42 | 7.82 |
| 4 | 4.92 | 7.21 | 7.27 | 7.82 |

As shown in Table 3, upon initial heating, the buffered Ca(NO₃)₂·4 H₂O Base Fluid demonstrated a neutral or higher pH, as required for use in oil and gas applications.

### Sodium Metatungstate Examples

In Example 4-6 below, various measurements were performed based on a sodium metatungstate ((Na)₆W₁₂O₃₉·H₂O ) Base Fluid, prepared as follows:

Dissolve up to 4 grams of (Na)₆W₁₂O₃₉·H₂O into 1 mL DI water for about 3.0 g/mL solution.

The (Na)₆W₁₂O₃₉·H₂O Base Fluid was thereafter stored at 4° C.

### Example 4: Stability of Sodium Metatungstate Base Solution

In this Example, the (Na)₆W₁₂O₃₉·H₂O Base Fluid was tested for stability. A sample of the (Na)₆W₁₂O₃₉·H₂O Base Fluid was stored for nine (9) months at 4° C., and thereafter, no precipitation or turbidity was observed. The results are shown in FIG. 5.

### Example 5: Density of Sodium Metatungstate Base Solution

In this Example, after storage for nine (9) months at 4° C., the density of the (Na)₆W₁₂O₃₉·H₂O Base Fluid was evaluated at varying concentrations. The results are shown in FIG. 6 and reported in Table 4.

TABLE 4

| (Na)₆W₁₂O₃₉ • H₂O | Property of solution |
|---|---|
| g solute/g H₂O | Density (g/mL) |
| 0.0 | 1.0069 |
| 0.5 | 1.4063 |
| 1.0 | 1.7198 |
| 2.0 | 2.1692 |
| 3.0 | 2.5581 |
| 4.0 | 2.8286 |

As shown, at concentrations equal to and greater than about 0.5 grams (g) of (Na)₆W₁₂O₃₉·H₂O, the density is about 1.5 g/mL and above at 4° C., which is suitable for oil and gas applications, such as drill-in and completion operations.

### Example 6: Density and pH Evaluation of Various Buffer and Polymer Loadings of Sodium Metatungstate

In this Example, various samples, labeled S1-S10, based on 0.5% aqueous (Na)₆W₁₂O₃₉·H₂O Solution were prepared. At the outset, a polymer solution and a trisodium phosphate dodecahydrate (TSP) alkaline solution were prepared, as provided below.

Polymer Solution: Add 50.5 g isobutlyene-maleic anhydride copolymer (ISOBAM™ 104, Japan), 0.5 g TSP, 9.0 g NaOH into 200 mL DI water. Stir until completely dissolved into solution. Allow solution to rest for 30 minutes at RT to completely degas into a clear yellow solution.

TSP Alkaline Solution: Add 0.5 TSP and 9.0 NaOH to 200 mL of DI water.

0.5% Aqueous (Na)₆W₁₂O₃₉·H₂O Solutions

S1: Add 1 mL of (Na)₆W₁₂O₃₉·H₂O Base Fluid to 1 mL of TSP Alkaline Solution (above). Stir for 5 min at RT.

S2: Add 1 mL of (Na)₆W₁₂O₃₉·H₂O Base Fluid to 1 mL of TRIS buffer (0.1M, pH 8.5). Stir for 5 min at RT.

S3: Add 1 mL of (Na)₆W₁₂O₃₉·H₂O Base Fluid to 1 mL of NaOH (1.1M). Stir for 5 min at RT.

S4: Add 1 mL of (Na)₆W₁₂O₃₉·H₂O Base Fluid to 1 mL of HCl (1M). Stir for 5 min at RT.

S5: Add 1 mL of (Na)₆W₁₂O₃₉·H₂O Base Fluid to 1 mL of Polymer Solution (above). Stir for 5 min at RT.

S6: Add 1 mL of (Na)₆W₁₂O₃₉·H₂O Base Fluid to 1 mL of NHO₃ (nitric oxide, 1N). Stir for 5 min at RT.

Each of S1-S6 were visually observed and the results are shown in FIG. 7. As shown, no precipitation or turbidity was observed. The density and pH was further evaluated and the results are shown in Table 5.

TABLE 5

| Sample | Density (g/mL) | pH |
|---|---|---|
| S1 | 1.92 | 8.12 |
| S2 | 1.92 | 7.16 |
| S3 | 1.92 | 8.12 |
| S4 | 1.88 | <1 |
| S5 | 1.95 | 7.6 |
| S6 | 1.91 | <1 |

As shown, the S5 sample is capable of having a polymer added thereto without compromising desired density and pH. As shown in FIG. 7, each of S1-S6 were additionally clear (clear).

Notably, a sample S6 was prepared by adding 4 g of (Na)₆W₁₂O₃₉·H₂O Base Fluid to 1 mL of NaOH (1.1M), which demonstrated a density of 2.58 g/mL and a pH of 7.64. Thus, the amount of (Na)₆W₁₂O₃₉·H₂O can be used to adjust the density of the clear heavy brine-based fluids of the present disclosure, as well as the pH.

### Example 7: Synthesis of TEPA_{1.5}[W₁₂O₄₀·xH₂O] and Stability by Measuring Corrosion Rate of Sodium Metatungstate

In this Example, corrosion measurements were performed based on two clear sodium metatungstate (Na)₆W₁₂O₃₉·H₂O) Base Fluids, prepared as follows:

S7 (Control): Dissolve 200 grams of (Na)₆W₁₂O₃₉·H₂O into 92 mL fresh water, stirring for 30 minutes (to allow complete dissolution). Add 0.22 grams of potassium hydroxide (KOH) and 68.5 milligrams of the reagent 2-amino-2-methyl-1-propanol (for thermal stability) and mix for 5 minutes to obtain a clear solution (2.3 g/mL). S7 was not buffered, prepared at RT, and had a pH of 9.0. After the corrosion study (at 180° F.), the pH of S7 decreased to 4.9.

S8: Dissolve 525 grams of (Na)₆W₁₂O₃₉·H₂O into 350 mL fresh water, stirring for 30 minutes (to allow complete dissolution). Add 50 milliliters of TEPA at high shear and heat at 110° C. overnight (16 hours). Filter the mixture and add 20 mL of sodium hydroxide (NaOH) (6M) to the filtrate and mix for five (5) minutes to obtain a clear solution. S8 had a pH of 10.3 after 22 days at 85° C.

S7 and S8 were prepared for corrosion testing using ASTM G1-90 (1999) and the corrosion rate was determined using ASTM G31-72 (2004). The results are shown in Table 6:

TABLE 6

| | | Millimeters | | Mils penetration |
|---|---|---|---|---|
| | | per year | | per year |
| Sample | pH | (mm/y) | (+/−) | (mpy) |
| S7 | 4.9 | 2.16 | 0.05 | 85.2 |
| S8 | 10.3 | 0.13 | 0.02 | 4.93 |

As shown, the inclusion of the stabilizer, TEPA, imparts substantial corrosion resistance and thus stability, providing a low-cost, environmentally-friendly solids-free, clear heavy brine-based fluids that is suitable for use in primary well control operations or other oil and gas operations.

Other reagents (pKa 7-10.5) to make solutions and control pH include, but are not limited to, 4-(cyclohexylamino)-1-butanesulfonic acid, 3-(cyclohexylamino)propanesulfonic acid, 2-amino-2-methyl-1-propanol, 3-(cyclohexylamino)-2-hydroxypropanesulfonic acid, 2-(cyclohexylamino)ethanesulfonic acid, N-(1,1-Dimethyl-2-hydroxyethyl)-3-amino-2-hydroxypropanesulphonic acid, 2-Amino-2-(hydroxymethyl)-1,3-propanediol, glycinamide, N,N-Bis(2-hydroxyethyl)glycine, N-(Tris(hydroxymethyl)methyl)glycine, 3-(cyclohexylamino)propanesulfonic acid, 3-[N-Tris-(hydroxymethyl)methylamino]-2-hydroxypropanesulfonic acid, hydroxy-3-{[2-hydroxy-1,1-bis(hydroxymethyl)-ethyl]amino}-1-propanesulphonic acid, 3-(cyclohexylamino)-2-hydroxypropanesulfonic acid, 2-(Cyclohexylamino)ethanesulfonic acid, 3-{[2-Hydroxy-1,1-bis(hydroxymethyl)ethyl]amino}-1-propanesulphonic acid, piperazine-1,4-bis(2-hydroxypropanesulfonic acid) dihydrate, N-(1,1-Dimethyl-2-hydroxyethyl)-3-amino-2-hydroxypropanesulphonic acid, β-hydroxy-4-(2-hydroxyethyl)piperazine-1-propanesulfonic acid, 3-[4-(2-Hydroxyethyl)-1-piperazinyl]propanesulfonic acid, triethyleneamine, and any combination thereof.

Example 8: Synthesis of TEPA_{1.5}[W₁₂O₄₀·xH₂O] and Stability by Measuring Corrosion Rate of Sodium Metatungstate

In this Example, corrosion measurements were performed based on two clear sodium metatungstate (Na)₆W₁₂O₃₉·H₂O) Base Fluids, prepared as follows:

### Example 8: Rheology of Sodium Metatungstate

In this Example, rheology measurements were performed based on a clear sodium metatungstate (Na)₆W₁₂O₃₉·H₂O) Base Fluid, prepared as follows:

Mix 1.56 g of KOH with fresh water, pre-hydrate a 0.4% w/v xanthan gum solution in fresh water overnight, and pre-hydrate a 0.5% w/v carboxymethyl cellulose solution in the fresh water overnight. Mix at high shear 20.8 mL of fresh water, 145 mL of the pre-hydrated xanthan gum solution, 145 mL of the pre-hydrated carboxymethyl cellulose solution, and 700 grams of (Na)₆W₁₂O₃₉·H₂O; dissolve completely (stir) and shear for five (5) minutes at RT to obtain a clear fluid.

The xanthan gum functions as a viscosifier, but additionally may provide fluid loss control. The carboxymethyl cellulose functions to provide fluid loss control, other examples include those described herein, such as a modified starch or other modified cellulose.

Rheology measurements were taken before hot rolling (BHR) according to API-RP-13D (2017) at RT.

Rheological measurements include, as provided in Table 7 below, plastic viscosity (“PV”), yield point (“YP”), and low-shear yield point (“LSYP. Rheology measurements were taken using a viscometer at shear rates of 3 revolutions per minute (“rpm”), 6 rpm, 100 rpm, 200 rpm, 300 rpm, and 600 rpm. The YP is defined as the value obtained from the Bingham-Plastic rheological model when extrapolated to a shear rate of zero and may be calculated using 300 rpm and 600 rpm shear rate readings. The YP is expressed as a force per area, such as pounds of force per one hundred square feet foot-pounds per 100 square feet (lbf/100 ft2). As an example, a drilling or completion fluid for primary well control having a YP of equal to or greater than 15 lbf/100 ft² is considered acceptable for drilling a wellbore. The PV represents the viscosity of a fluid when extrapolated to infinite shear rate. The LSYP estimates the yield stress at the lowest shear stress value above which a material will behave like a fluid and below which the material will behave like a solid.

The PV and YP are calculated according to Equation 1 and Equation 2, respectively:

PV=(600 rmp reading)−(300 rpm reading) Equation 1

YP=(300 rmp reading)−PV Equation 2

The LSYP is calculated according to Equations 2, except with the 600 rpm and 300 rpm readings (in Equations 1 and 2) substituted for 6 rpm and 3 rpm readings, respectively.

The results of the rheological measurements for this Examples are provided in Table 7 below:

TABLE 7

| Viscometer Shear Rate | Viscometer |
|---|---|
| (RPM) | Readings |
| 600 | 75 |
| 300 | 51 |
| 200 | 41 |
| 100 | 29 |
| 6 | 9 |
| 3 | 6 |

| | Rheology |
|---|---|
| | Measurements |
| Rheology Properties | (BHR, RT) |
| 10 second gel strength | 8 |
| (lbf/100 ft²) | |
| 10 minute gel strength | 9 |
| (lbf/100 ft²) | |
| PV (cP) | 24 |
| YP (lbf/100 ft²) | 27 |
| LSYP (lbf/100 ft²) | 3 |

Accordingly, the clear heavy brine-based fluids of the present disclosure exhibit good rheological measurements for use in primary well control applications. These fluids are further amenable to polymeric additives, as shown in Tables 7.

### Example 9: Rheology of Sodium Metatungstate with Additive for Drill-In Fluid

In this Example, rheology measurements were performed based on two clear sodium metatungstate (Na)₆W₁₂O₃₉·H₂O) Base Fluids, prepared as follows:

Mix 1.56 g of KOH with fresh water, pre-hydrate a 0.4% w/v xanthan gum solution in fresh water overnight, and pre-hydrate a 0.5% w/v carboxymethyl cellulose solution in fresh water overnight. Mix at high shear 20.8 mL of fresh water, 145 mL of the pre-hydrated xanthan gum solution, 145 mL of the pre-hydrated carboxymethyl cellulose solution, and 700 grams of (Na)₆W₁₂O₃₉·H₂O; dissolve completely (stir) and shear for five (5) minutes at RT to obtain a clear fluid. Add 84 grams calcium carbonate (e.g., TRUECARB 25®, fine) and shear for five (5) minutes at RT.

The composition elements function as described in Example 8, and the calcium carbonate serves as a filter cake agent.

Rheology (BHR) measurements were taken according to API-RP-13D (2017) at RT, as shown in Table 8. The pH of the solution tested in Table 8 was 6.9.

TABLE 8

| Viscometer Shear Rate | Viscometer |
|---|---|
| (RPM) | Readings |
| 600 | 115 |
| 300 | 69 |
| 200 | 55 |
| 100 | 47 |
| 6 | 11 |
| 3 | 8 |

| | Rheology |
|---|---|
| | Measurements |
| Rheology Properties | (BHR, RT) |
| 10 second gel strength | 10 |
| (lbf/100 ft²) | |
| 10 minute gel strength | 10 |
| (lbf/100 ft²) | |
| PV (cP) | 46 |
| YP (lbf/100 ft²) | 23 |
| LSYP (lbf/100 ft²) | 5 |

After adding the calcium carbonate and shearing for fine (5) minutes, the formulation was hot rolled at 150° F. for 16 hours (˜65.6° C.). Rheology measurements were taken after hot rolling (AHR) according to API-RP-13D (2017) at RT and at 120° F. (˜48.9° C.), as shown in Table 9. The cell weight was 2.1 FL and 2.32 FC. The pH of the solution tested at 120° C. in Table 9 was 5.9.

TABLE 9

| Viscometer | Viscometer | Viscometer |
|---|---|---|
| Shear Rate | Readings | Readings |
| (RPM) | (RT) | (120° F.) |
| 600 | 107 | 112 |
| 300 | 72 | 75 |
| 200 | 57 | 58 |
| 100 | 39 | 38 |
| 6 | 10 | 8 |
| 3 | 8 | 6 |

| | Rheology | Rheology |
|---|---|---|
| | Measurements | Measurements |
| Rheology Properties | (AHR, RT) | (AHR, 120° C.) |
| 10 second gel strength | 9 | 6 |
| (lbf/100 ft²) | | |
| 10 minute gel strength | 10 | 7 |
| (lbf/100 ft²) | | |
| 30 minute gel strength | | — |
| (lbf/100 ft²) | | |
| PV (cP) | 35 | 37 |
| YP (lbf/100 ft²) | 37 | 38 |
| LSYP (lbf/100 ft²) | 6 | 4 |

Accordingly, the clear heavy brine-based fluids of the present disclosure exhibit good rheological measurements for use in primary well control applications, and can accommodate additives, such as filter cake agents and fluid loss control agents to obtain drill-in fluids, that show high production rates with low skin. These fluids are further amenable to polymeric additives, as shown in Tables 8 and 9. Such formulations may further advantageously provide drill-in fluids that are o/w or w/o based.

### Example 10: Solubility of Solids v. Temperature of a Clear Heavy Brine-Based Sodium Metatungstate Fluid

In this Example, provided is temperature-dependent solubility chart of a clear heavy brine-based (Na)₆W₁₂O₃₉·H₂O fluid at varying concentrations prepared according to one or more embodiments of the present disclosure.

In deep-water operations, for example, the temperature gradient is vast between surface temperatures at sea and bottomhole temperatures. Operators typically choose fluids for an operation based on the true vertical depth (TVD), bottomhole pressure (BHP), and bottomhole temperature (BHT) of the well being treated. Further, since the fluid is subjected to heating and cooling during a treatment operation, the temperature profile along the entire path to which the fluid is exposed during the treatment operation is also considered. The TCT (or saturation point) or PCT of a fluid is the temperature at which a solid phase begins to form, resulting in a mixture of solid particles and solution.

Traditional clear-brine completion/workover fluids are prepared with soluble salts to increase density. These fluids are blended to certain specifications to take into consideration density, TCT (freeze points), PCT (pressure/temperature freeze points), and clarity. Solid salts form once the temperature of the brine is cooled below its TCT. Typically, the TCT is the determining factor when selecting a clear brine fluid for a completion/workover application. Thus, the formation of solids puts increased demands on pumping equipment in light of the increased resistance to fluid flow. In addition, the loss of soluble salts by settling or filtration drastically reduces the density of the completion fluid. Loss of density of the clear brine can result in an underbalanced situation.

As shown in FIG. 8, the TCT of a clear heavy brine-based fluid comprising (Na)₆W₁₂O₃₉·H₂O does not increase with increasing density, but rather decreases at both ambient (15 psi) and 10,000 pounds per square inch (psi) confined pressure for fluids prepared up to 24 ppg. FIG. 8 shows crystallization points but no eutectic point for the illustrated concentrations at 15 psi and 10,000 psi pressures. The high-density fluid at ˜23 ppg has the lowest crystallization/freezing point.

Accordingly, the clear heavy brine-based fluids of the present disclosure are suitable for use in oil and gas operations, including operations for primary wellbore control using fluids.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, applications, elements, and/or components, but do not preclude the presence or addition of one or more other features, integers, steps, applications, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A clear heavy brine-based fluid comprising:
a solute of calcium nitrate tetrahydrate or sodium metatungstate; and
an aqueous carrier fluid,
wherein the clear heavy brine-based fluid has a density in the range of about 1.5 g/mL to about 3 g/mL; and
wherein the solute is present in the clear heavy brine-based fluid in an amount of from about 136 wt. % to about 200 wt. % of the aqueous carrier fluid.

2. (canceled)

3. The clear heavy brine-based fluid of claim 1, wherein the solute is calcium nitrate tetrahydrate.

4. The clear heavy brine-based fluid of claim 3, wherein the calcium nitrate tetrahydrate is present in the clear heavy brine-based fluid in an amount of from about 0.2 wt. % to about 200 wt. % of the aqueous carrier fluid.

5. The clear heavy brine-based fluid of claim 1, wherein the solute is sodium metatungstate.

6. The clear heavy brine-based fluid of claim 5, wherein the sodium metatungstate is present in the clear heavy solids-free brine-based in an amount of from about 0.2 wt. % to about 150 wt. % of the aqueous carrier fluid.

7. The clear heavy brine-based fluid of claim 1, wherein the aqueous carrier fluid is selected from the group consisting of freshwater, deionized water, brine, seawater, produced water, and any combination thereof.

8. The clear heavy brine-based fluid of claim 1, further comprising an additive selected from the group consisting of a buffering agent, a corrosion inhibitor, a counter ion, a secondary weighting agent, a chelate, a viscosifier, a surfactant, a ligand modifier, a stabilizer, and any combination thereof.

9. A method comprising:
introducing a clear heavy brine-based fluid into a subterranean formation, the clear heavy brine-based comprising:
a solute of calcium nitrate tetrahydrate or sodium metatungstate; and
an aqueous carrier fluid,
wherein the clear heavy brine-based fluid has a density in the range of about 1.5 g/mL to about 3 g/mL and the solute is present in the clear heavy brine-based fluid in an amount of from about 136 wt. % to about 200 wt. % of the aqueous carrier fluid.

10. The method of claim 9, further comprising drilling a wellbore in the subterranean formation while introducing the clear heavy brine-based fluid as a primary well control fluid.

11. The method of claim 9, further comprising fracturing the subterranean formation while introducing the clear heavy brine-based fluid.

12. (canceled)

13. The method of claim 9, wherein the solute is calcium nitrate tetrahydrate.

14. (canceled)

15. The method of claim 9, wherein the solute is sodium metatungstate.

16. The method of claim 15, wherein the sodium metatungstate is present in the clear heavy brine-based fluid in an amount of from about 0.2 wt. % to about 150 wt. % of the aqueous carrier fluid.

17. The method of claim 9, wherein the aqueous carrier fluid is selected from the group consisting of freshwater, deionized water, brine, seawater, produced water, and any combination thereof.

18. The method of claim 9, wherein the clear heavy brine-based fluid further comprises an additive selected from the group consisting of a buffering agent, a corrosion inhibitor, a counter ion, a secondary weighting agent, a chelate, a viscosifier, a surfactant, a ligand modifier, a stabilizer, and any combination thereof.

19. A system comprising:
a drill string extendable into a wellbore from a drilling platform and conveying a clear heavy brine-based fluid to a drill bit arranged at a distal end of the drill string, the clear heavy brine-based fluid comprising:
a solute of calcium nitrate tetrahydrate or sodium metatungstate; and
an aqueous carrier fluid,
wherein the clear heavy brine-based fluid has a density in the range of about 1.5 g/mL to about 3 g/mL and the solute is present in the clear heavy brine-based fluid in an amount of from about 136 wt. % to about 200 wt. % of the aqueous carrier fluid.

20. (canceled)
